(19) United States
(12) Patent Application Publication
(10) Pub. No.: US 2026/0045535 A1
(43) Pub. Date: Feb. 12, 2026

(54) RECHARGEABLE BATTERY AND METHOD OF DESIGNING RECHARGEABLE BATTERY

(71) Applicant: SAMSUNG SDI CO., LTD., Yongin-si (KR)

(72) Inventors: Eunseok OH, Yongin-si (KR); Hanbyeol JANG, Yongin-si (KR); Seokyo JEOUNG, Yongin-si (KR); Taesu JEONG, Yongin-si (KR); Jaehyeon YUN, Yongin-si (KR)

(21) Appl. No.: 19/231,648

(22) Filed: Jun. 9, 2025

(30) Foreign Application Priority Data
Aug. 7, 2024 (KR) 10-2024-0105668

(51) Int. Cl. H01M 10/04

(52) U.S. Cl. CPC H01M 10/0431

(57) ABSTRACT

A method of designing a rechargeable battery includes a numerical value entering operation for entering detailed numerical values for a case, a separator, and an electrode plate, a calculation operation for deriving X and until an equation is satisfied, and a position-setting operation for setting the position of an electrode tab to be located on one side of the electrode plate.

### CROSS-REFERENCE TO RELATED APPLICATION

The present application claims priority to and the benefit of Korean Patent Application No. 10-2024-0105668, filed on Aug. 7, 2024, in the Korean Intellectual Property Office, the entire disclosure of which is incorporated herein by reference.

### BACKGROUND

### 1. Field

Aspects of some embodiments of the present disclosure relate to a rechargeable battery and a method of designing the rechargeable battery.

### 2. Description of the Related Art

Rechargeable batteries may be manufactured in various shapes such as cylindrical and square. Here, an electrode assembly is installed inside a case of the rechargeable battery. The electrode assembly may be manufactured in various shapes, such as jelly-roll type and stack type.

In a method of manufacturing a jelly-roll-type electrode assembly, a laminate formed of a separator and an electrode plate is wound around two beams. A plurality of electrode tabs extending from the electrode plate are then welded together. At this time, the positions of the plurality of electrode tabs may desirably be aligned.

The above information disclosed in this Background section is only for enhancement of understanding of the background and therefore the information discussed in this Background section does not necessarily constitute prior art.

### SUMMARY

Aspects of some embodiments include a rechargeable battery and a method of designing or manufacturing the rechargeable battery capable of aligning electrode tabs.

Characteristics that may be obtained from the present disclosure will not be limited to only the above-described effects, and other characteristics which are not described herein will become apparent to those skilled in the art from the following description.

A method of designing a rechargeable battery according to some embodiments of the present disclosure for solving the above technical problem includes a numerical value entering operation for entering, identifying, or controlling (e.g., by a processor) detailed numerical values for a case, a separator, and an electrode plate, a calculation operation for deriving X and a until they satisfy the following Equation 1, and a position-setting operation for setting (e.g., by the processor) the position of an electrode tab to be located or arranged on one side of the electrode plate.

$${\sum }_{k = 1}^{n} ( X + ( k - 1 ) a ) = M - G \qquad Equation 1$$

(M is the length of the electrode plate, G is the length of an uncoated portion without an active material layer on the electrode plate, n is twice the number of windings (×2), X is the length of a unit electrode plate when wound 0.5 times, and a is the increase (increment) in the length of the unit electrode plate per winding.)

According to some embodiments, in the calculation operation, the X and the a may be derived using one of trial and error, exhaustive search, gradient method, generic algorithm (GA), and particle swarm optimization (PSO).

According to some embodiments, the X in the calculation operation may be a value included in a range of 60% to 90% of the width of the case.

According to some embodiments, in the position-setting operation, the distance from the center of the unit electrode plate to the center of the electrode tab may be set to be the same for each of the number of windings.

According to some embodiments, a number-setting operation for setting (e.g., by a processor) the number of electrode tabs may be further included.

According to some embodiments, in the number-setting operation, electrode tabs other than the required ones may be deleted from the total number of electrode tabs.

A rechargeable battery according to some embodiments of the present disclosure includes an electrode assembly including a separator and an electrode plate located or arranged with the separator therebetween, and a case for accommodating the electrode assembly, wherein the electrode assembly satisfies the following Equation 1.

$${\sum }_{k = 1}^{n} ( X + ( k - 1 ) a ) = M - G \qquad Equation 1$$

According to some embodiments, the electrode plate may include a coated portion having an active material layer.

According to some embodiments, the electrode plate may include the coated portion having the active material layer, and an uncoated portion without the active material layer.

According to some embodiments, the electrode plate may include a positive electrode plate and a negative electrode plate.

According to some embodiments of the present disclosure, the method of designing the rechargeable battery automates the process of setting the position of the electrode tab, so that the position of the electrode tab may be relatively accurately set regardless of the user's skill level.

Therefore, the electrode tabs may be aligned during the process of winding the laminate including the separator and the electrode plate to manufacture the electrode assembly.

### BRIEF DESCRIPTION OF THE DRAWINGS

The accompanying drawings illustrate aspects of some embodiments of the present disclosure and, together with the foregoing disclosure, serve to provide further understanding of the technical spirit of the present disclosure, but the present disclosure is not to be construed as being limited to the drawings.

FIG. 1 is a top plan view illustrating an electrode assembly manufactured by a conventional method of designing a rechargeable battery.

FIG. 2 is an exploded perspective view illustrating a rechargeable battery that may be manufactured by a method of designing the rechargeable battery according to some embodiments of the present disclosure.

FIG. 3 is an exploded view illustrating a positive electrode plate of the rechargeable battery of FIG. 2.

FIG. 4 is an exploded view illustrating a negative electrode plate of the rechargeable battery of FIG. 2.

FIG. 5 is a flowchart illustrating a method of designing a rechargeable battery according to some embodiments of the present disclosure.

FIG. 6 illustrates an electrode plate of the electrode assembly of FIG. 2, viewed from direction A.

FIG. 7 is an exploded view illustrating the electrode plate of FIG. 6 cut at 0.5 turn intervals.

FIG. 8 is an exploded view illustrating one unit electrode plate extracted from the electrode plate of FIG. 6.

FIG. 9 illustrates a process in which a number-setting operation is performed after a position-setting operation to reduce the number of electrode tabs.

FIG. 10 is a top plan view illustrating an electrode assembly manufactured by a method of designing a rechargeable battery according to some embodiments of the present disclosure.

FIG. 11 is a photograph of an electrode assembly manufactured by a method of designing a rechargeable battery according to some embodiments of the present disclosure.

### DETAILED DESCRIPTION

Hereinafter, aspects of some embodiments of the present disclosure will be described in more detail with reference to the accompanying drawings. Prior to making the description, the terms and words used in the specification and claims of the present disclosure are not to be construed in their ordinary or dictionary sense, but rather as meanings and concepts conforming to the technical spirit of the present disclosure based on the principle that the inventor can appropriately define the concepts of the terms to explain the present disclosure in the best manner. Accordingly, it is to be understood that the detailed description, which will be disclosed along with the accompanying drawings, is intended to describe the embodiments of the present disclosure and is not intended to represent all technical ideas of the present disclosure, so it should be understood that various equivalents and modifications can exist which can replace the embodiments described in the present disclosure.

It should be further understood that the term “comprise” or “include” and/or “comprising” or “including,” when used in this specification, specify the presence of stated features, numbers, steps, operations, elements, and/or components, but do not preclude the presence or addition of one or more other features, numbers, steps, operations, elements, components, and/or groups thereof.

In addition, for ease of understanding of the present disclosure, the accompanying drawings are not drawn to actual scale, but the dimensions of some components may be exaggerated. In addition, the same reference numbers may be assigned to the same components in different embodiments.

Stating that two objects of comparison are “the same” means that they are “substantially the same.”

Therefore, substantially identical may include a deviation that is considered low in the art—for example, a deviation of less than 5%. Additionally, uniformity of a parameter in a certain region may mean uniformity from an average perspective.

Although the terms “first,” “second,” and the like are used to explain various components, the components are not limited to such terms. These terms are only used to distinguish one component from another component, and unless explicitly stated to the contrary, the second component may be referred to as the first component.

Throughout the specification, unless otherwise stated, each component may be singular or plural.

It should also be understood that when a first element or layer is referred to as being “on” or “beneath” a second element or layer, the first element may be located directly on or beneath the second element or may be located or arranged indirectly on or beneath the second element with a third element or layer being located or arranged between the first and second elements or layers.

It should be noted that if it is stated in the specification that one component is “connected,” or “coupled” to another component, a third component may be “connected,” “coupled,” and “joined” between the first and second components, although the first component may be directly connected, coupled, or joined to the second component.

As used herein, the term “and/or” includes any one and all combinations of one or more of the associated listed items. Additionally, the use of “may” when describing embodiments of the present disclosure relates to “one or more embodiments of the present disclosure.”

Expressions such as “one or more” and “at least” preceding a list of elements modify the entire list of elements and do not modify individual elements in the list.

When reference is made to “A and/or B” throughout the specification, it means A, B, or A and B, unless specifically stated to the contrary, and when referring to “C to D”, it means that it is greater than or equal to C and less than or equal to D, unless otherwise specified.

When phrases such as “at least one of A, B, and C,” “at least one of A, B, or C,” “at least one selected from the group of A, B, and C,” and “at least one selected from A, B, and C” are used to specify a list of elements A, B, and C, the phrases may refer to any suitable combination.

The term “use” may be considered synonymous with the term “utilize.”

As used herein, the terms “substantially,” “about,” and similar terms are used as terms of approximation and are intended to account for inherent variations in the measured or calculated values that would be recognized by a person of ordinary skill in the art.

It should be understood that, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

Spatially relative terms, such as “beneath,” “below,” “lower,” “above,” “upper,” and the like, may be used herein for ease of description to describe the relationship of one element or feature to another element(s) or feature(s) as illustrated in the drawings. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “on” or “above” the other elements or features. Thus, the term “below” can encompass both an orientation of above and below.

The terminology used herein is for the purpose of describing particular embodiments only and is not intended to limit the disclosure.

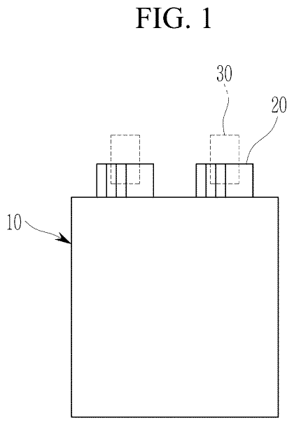

FIG. 1 is a top plan view illustrating an example electrode assembly manufactured by a method of assembling a rechargeable battery.

Referring to FIG. 1, if electrode tabs 20 in an electrode assembly 10 are not aligned, a defect may occur during welding with strip terminals 30.

To solve this problem, in some systems, a user may use a pen to mark the position where the electrode tab should be on the electrode plate, and create the electrode tab at that position to manufacture the product. Therefore, it may be relatively time consuming to manufacture a rechargeable battery, but defective products with misaligned electrode tabs may need to be discarded, and the manufacturing quality of the rechargeable battery may vary depending on the skill level of the user.

Before describing a method of designing or manufacturing a rechargeable battery according to some embodiments of the present disclosure, further details of rechargeable battery are described below.

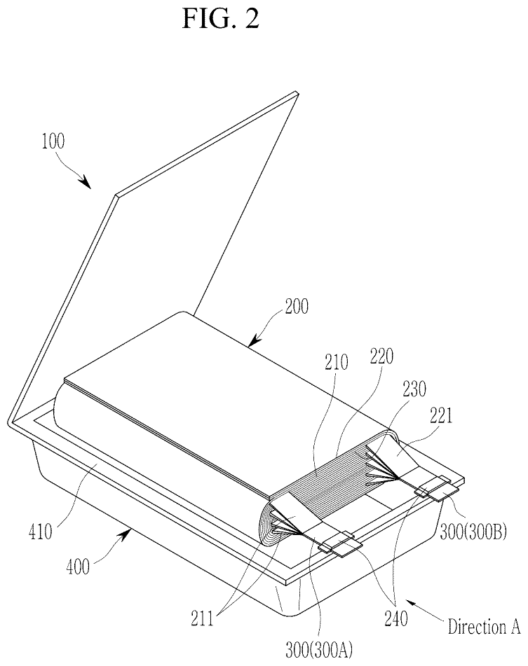

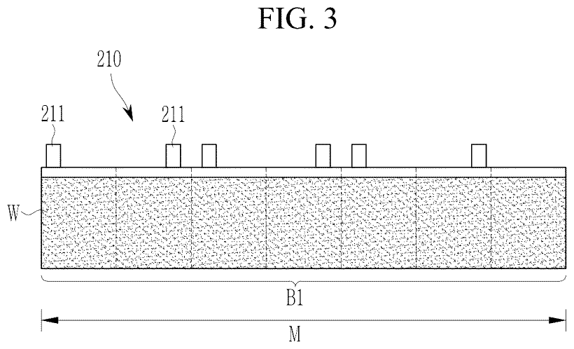

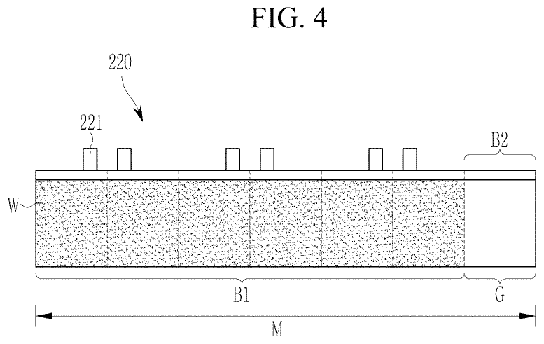

FIG. 2 is an exploded perspective view illustrating a rechargeable battery that may be manufactured by a method of designing the rechargeable battery according to some embodiments of the present disclosure, FIG. 3 is an exploded view illustrating a positive electrode plate of the rechargeable battery of FIG. 2, and FIG. 4 is an exploded view illustrating aspects of a negative electrode plate of the rechargeable battery of FIG. 2.

Referring to FIGS. 2 to 4, a rechargeable battery 100 may include an electrode assembly 200, an electrode lead 300, and a case 400.

The electrode assembly 200 includes a plurality of electrode plates 210 and 220 and a separator 230. For example, the plurality of electrode plates 210 and 220 may include a first electrode plate 210 and a second electrode plate 220.

The electrode assembly 200 may be in the form of a stack including the first electrode plate 210, the second electrode plate 220, and the separator 230 being repeatedly wound or stacked.

For example, the electrode assembly 200 may be formed in a stacked arrangement in which electrode plates 210 and 220 are stacked in multiple layers. Alternatively, the electrode assembly 200 may be of a repeatedly wound jelly-roll type or configuration.

In this case, there may be one first electrode plate 210 and one second electrode plate 220. The jelly-roll-type electrode assembly 200 may be manufactured in a manner in which a laminate in which the first electrode plate 210, the separator 230, and the second electrode plate 220 are stacked on each other is wound on two winding beams.

In the present disclosure, the electrode assembly 200 of the jelly-roll type or configuration is described as an example, but embodiments according to the present disclosure are not limited thereto.

The separator 230 may be interposed between the first electrode plate 210 and the second electrode plate 220. The separator 230 prevents or reduces shorting between the first electrode plate 210 and the second electrode plate 220, and enables movement of lithium ions. To this end, the separator 230 may be relatively larger in size than the first electrode plate 210 or the second electrode plate 220.

The material of the separator 230 may be, for example, polyethylene, polypropylene, or a composite film of polyethylene and polypropylene, but embodiments according to the present disclosure are not limited thereto.

The separator 230 may also be installed or manufactured in a configuration in which it is wound in one direction between the first electrode plate 210 and the second electrode plate 220. In contrast, in a configuration in which the electrode plates 210 and 220 are in a stacked form or arrangement, the separator 230 may be cut into unit lengths and arranged or formed between the first electrode plate 210 and the second electrode plate 220, or a single separator 230 formed in a ribbon shape may be arranged in a zigzag form or shape between the first electrode plate 210 and the second electrode plate 220. The arrangement of the separator 230 is not limited to a specific form, shape, or arrangement.

The electrode assembly 200 as described above includes electrode tabs 211 and 221. The electrode tabs 211 and 221 may extend from each of the first electrode plate 210 and the second electrode plate 220. The electrode tab extending from the first electrode plate 210 may be a first electrode tab 211, and the electrode tab extending from the second electrode plate 220 may be a second electrode tab 221.

The electrode lead 300 is connected to the electrode tabs 211 and 221. There may be two electrode leads 300A and 300B. One electrode lead 300A may be connected to the first electrode tab 211, and the remaining electrode lead 300B may be connected to the second electrode tab 221. That is, the first electrode plate 210 and the second electrode plate 220 may be electrically connected to the outside of the rechargeable battery 100 through the electrode lead 300.

Meanwhile, a protective member 240 may wrap a portion of the electrode lead 300 corresponding to the case 400. The protective member 240 may prevent or reduce instances of electrical connection between the electrode lead 300 and the case 400.

The case 400 may accommodate the electrode assembly 200. The electrode assembly 200 described above is accommodated in the case 400 together with an electrolyte.

The case 400 as described above may be one of a pouch type, a cylindrical type, and a square type. A pouch type case 400 may be manufactured by bending plate-shaped exterior materials to face each other, then pressing or drawing one surface and including a recess on the one surface.

The electrode assembly 200 is accommodated in a recess. A sealing portion 410 is provided on the outer periphery of the recess, and the sealing portion 410 is sealed by a method such as heat fusion while the electrode assembly 200 is accommodated in the recess.

Meanwhile, the plurality of electrode plates 210 and 220 may include a positive electrode plate and a negative electrode plate. The first electrode plate 210 described above may be used as a negative electrode plate, and the second electrode plate 220 may be used as a positive electrode plate, but the reverse may also be possible.

Further, the electrode tabs 211 and 221 may include a positive electrode tab (221) and a negative electrode tab (211). The negative electrode tab 211 may extend from the first electrode plate 210, and the positive electrode tab 221 may extend from the second electrode plate 220.

On the other hand, when the electrode plate 210 is divided by region, the electrode plate 210 may include a coated portion B1 having an active material layer W and an uncoated portion B2 without the active material layer W. However, depending on the design, the electrode plate 210 may also include only the coated portion B1 without the uncoated portion B2.

For example, as shown in FIG. 3, depending on the design of the rechargeable battery 100, the first electrode plate 210 may include only the coated portion B1 without the uncoated portion B2. And, as shown in FIG. 4, the second electrode plate 220 may include the coated portion B1 and the uncoated portion B2.

However, embodiments according to the present disclosure are not necessarily limited to the first electrode plate 210 including only the coated portion B1, and both the first electrode plate 210 and the second electrode plate 220 may include the coated portion B1 and the uncoated portion B2, and various other cases may also be possible.

Meanwhile, the electrode assembly 200 described above may satisfy the following Equation 1, which will be described in more detail in a method of designing a rechargeable battery (S100).

$${\sum }_{k = 1}^{n} ( X + ( k - 1 ) a ) = M - G \qquad Equation 1$$

Hereinafter, a method of designing a rechargeable battery according to some embodiments of the present disclosure that may be used to design the rechargeable battery 100 as described above will be described in more detail with reference to the drawings.

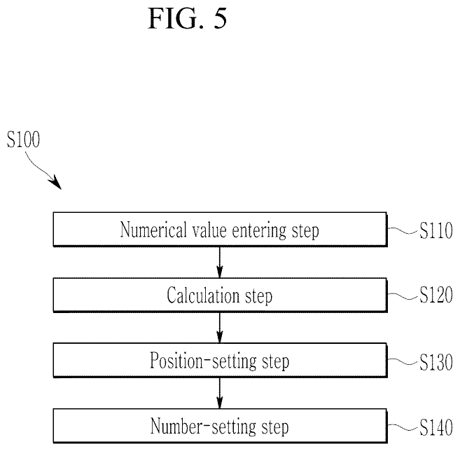

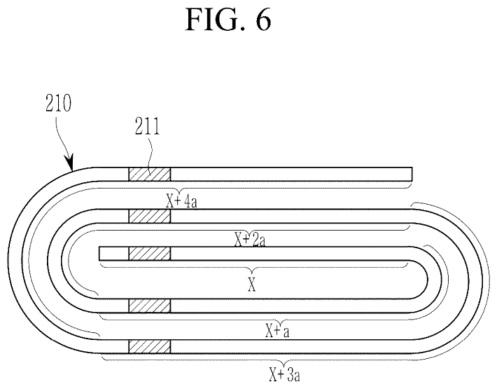

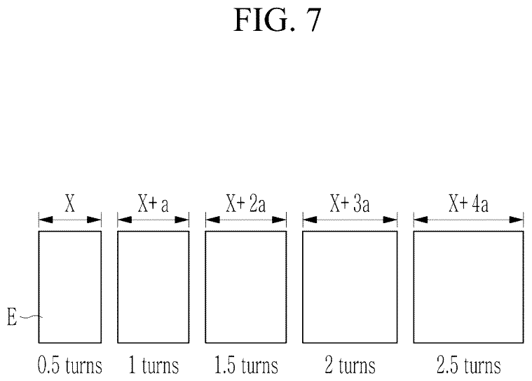

FIG. 5 is a flowchart illustrating aspects of a method of designing or manufacturing a rechargeable battery according to some embodiments of the present disclosure, FIG. 6 illustrates an electrode plate of the electrode assembly of FIG. 2, viewed from direction A, and FIG. 7 is an exploded view illustrating the electrode plate of FIG. 6 cut at 0.5 turn intervals. Although FIG. 5 illustrates various operations in a method of designing or manufacturing a rechargeable battery, embodiments according to the present disclosure are not limited thereto, and according to various embodiments, the method may include additional operations, or fewer operations, or the order of operations may vary, without departing from the spirit and scope of embodiments according to the present disclosure.

Referring to FIGS. 5 to 7, the method of designing the rechargeable battery (S100) according to some embodiments of the present disclosure may include a numerical value entering operation (S110), a calculation operation (S120), and a position-setting operation (S130).

The numerical value entering operation (S110) is an operation for entering detailed numerical values for each of the case (400, see FIG. 2) and the electrode plate 210.

In the numerical value entering operation (S110), various numerical values such as the width, length, and height of the case (400, see FIG. 2), as well as the thickness of the electrode plate 210, a length G of an uncoated portion (K, see FIG. 4), the thickness of the active material layer (W, see FIG. 3), and the number of turns of the electrode assembly 200 may be input. The numerical value entered in the numerical value entering operation (S110) is not limited to a numerical value.

The calculation operation (S120) is an operation for deriving X and a until the following Equation 1 is satisfied. The calculation operation (S120) derives X and a based on the numerical values entered in the numerical value entering operation (S110) until Equation 1 is satisfied. A further detailed description of the calculation operation (S120) will be provided later.

$${\sum }_{k = 1}^{n} ( X + ( k - 1 ) a ) = M - G \qquad Equation 1$$

M (see FIG. 4) is the length of the electrode plate 210, G (see FIG. 4) is the length G of the uncoated portion (K, see FIG. 4), n is twice the number of turns (×2), X is the length of a unit electrode plate E when wound 0.5 times, and a is the increase (increment) in the length of the unit electrode plate E per winding.

The position-setting operation (S130) is a operation for setting the position of the electrode tab 211 to be located or arranged on one side of the electrode plate 210. A further detailed description of the position-setting operation (S130) will be provided later.

Hereinafter, the process of deriving Equation 1 in the calculation operation (S120) included in the method of designing or manufacturing the rechargeable battery (S100) according to some embodiments of the present disclosure described above will be described in more detail.

The manufacturing process of a general electrode assembly is described as follows: a laminate in which a negative electrode plate, a separator, and a positive electrode plate are stacked is wound around two rod-shaped winding cores. For better comprehension and ease of description, the negative electrode plate and the positive electrode plate are collectively referred to as “electrode plates.”

Further, for ease of description, it is assumed that the first electrode plate 210 and the first electrode tab 211 are designed in a method of designing a rechargeable battery (S100) according to some embodiments of the present disclosure. A method of designing a rechargeable battery (S100) according to some embodiments of the present disclosure may also be used to design the second electrode plate 220 and the first electrode tab 221.

As the laminate including the separator (230, see FIG. 2) and the electrode plate 210 is wound one turn at a time, the thickness of the inner side excluding the outermost side gradually increases. Therefore, as the number of winding turns of the laminate increases, the length of the electrode plate 210 required for one turn of winding continues to increase. At this time, it is assumed that the length of the electrode plate 210 that increases with each turn is constant. For example, it is assumed that the length of the electrode plate of 0.5 turns→the length of the electrode plate of 1.0 turns→the length of the electrode plate of 1.5 turns all increase by a constant amount.

Therefore, a value is calculated such that the sum of the lengths of the electrode plates 210 for each turn and the length of the electrode plate 210 set according to the rechargeable battery specifications required by the customer are equal. At this time, by calculating the increment a of the electrode plate 210 for each turn, the length of the electrode plate 210 for each turn may be calculated. Here, the increment a is the difference between the length of the electrode plate 210 of the previous turn and the length of the electrode plate 210 of the next turn.

For the above reasons, Equation 1 described above may be applied to a method of designing or manufacturing a rechargeable battery (S100) according to some embodiments of the present disclosure.

In addition, in Equation 1, X is the length of the unit electrode plate E when wound 0.5 times, so it may be desirable for n to be twice the number of windings. For example, if the electrode plate 210 is to be rotated 2.5 turns, n may be 5. Accordingly, the sum of X, X+a, X+2a, X+3a, and X+4a may be equal to the value of M-G. Here, for electrode plates that do not include the uncoated portion, G may be “0.”

Meanwhile, in the calculation operation (S120), X and a may be derived using one of trial and error, exhaustive search, gradient method, generic algorithm (GA), and particle swarm optimization (PSO). And in the calculation operation (S120), X may be a value included in a range of 60% to 90% of the width of the case (400, see FIG. 2).

For example, when the width of the case (400, see FIG. 2) is set to 500 mm, the values for which Equation 1 is satisfied are found by continuously changing X and a to arbitrary values through trial and error. Here, X may be changed within a limited range of 60% to 90% of the width of the case (400, see FIG. 2) as described above.

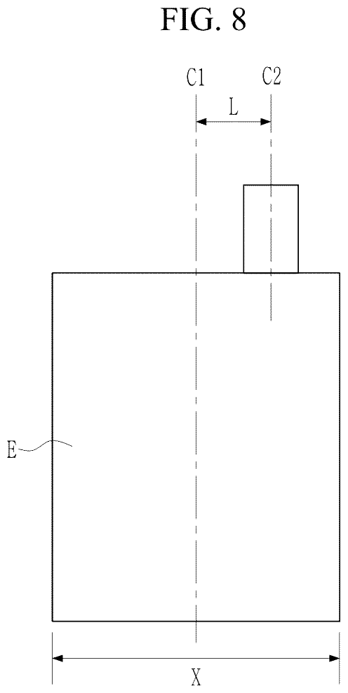

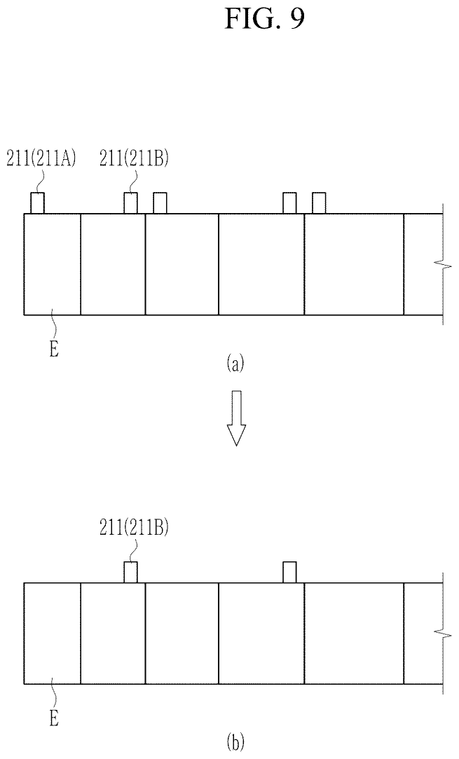

FIG. 8 is an exploded view illustrating one unit electrode plate extracted from the electrode plate of FIG. 6, and FIG. 9 illustrates a process in which a number-setting operation is performed after a position-setting operation to reduce the number of electrode tabs.

Referring to FIGS. 8 and 9, the position-setting operation (S130, see FIG. 5) described above is described in more detail.

In the rechargeable battery manufacturing process, the electrode tabs 211 extending from the negative electrode plate are welded by being in close contact with each other, and the electrode tabs 221 extending from the positive electrode plate are welded by being in close contact with each other. Therefore, a distance L from a center C1 of the electrode plate 210 to a center C2 of the electrode tab 211 for each turn must always be constant.

That is, as shown in FIG. 8, the position-setting operation (S130, see FIG. 5) sets the distance L from the center C1 of the unit electrode plate E to the center C2 of the electrode tab 211 to be the same for each number of windings. Accordingly, because the length of the electrode plate 210 is calculated for each turn as described above, the position of each electrode tab 211 that should be in each turn may also be set.

Meanwhile, a method of designing or manufacturing a rechargeable battery (S100, see FIG. 5) according to some embodiments of the present disclosure may further include a number-setting operation (S140, see FIG. 5).

In the number-setting operation (S140, see FIG. 5), the number of electrode tabs 211 is set. The number-setting operation (S140, see FIG. 5) may delete the remaining electrode tabs 211A except for required electrode tabs 211B from the entire electrode tabs 211.

For example, the positions of the electrode tabs 211A and 211B arranged or utilized for each turn are determined as described above. As shown in FIG. 9(a), in the position-setting operation (S130, see FIG. 5), the electrode plate 210 of the electrode assembly 200 is designed to have two electrode tabs 211 per turn.

The specifications of rechargeable batteries used in various electronic products are different. For electronic products that require instantaneous high output, such as power tools, the number of electrode tabs is maximized. In contrast, for electronic products that require continuous low output, such as auxiliary batteries, it may be desirable to limit the number of electrode tabs to a certain number.

Therefore, as shown in FIG. 9(b), the unnecessary electrode tab 211A is deleted to suit the design of the electrode assembly 200. For example, the number of electrode tabs 211A of the designed electrode assembly 200 is 10, and the total number of electrode tabs 211A and 211B set in advance is 20. Therefore, 10 unnecessary electrode tabs 211B may be deleted.

In the conventional rechargeable battery design process, users manually mark the positions of electrode tabs. Therefore, depending on the user's skill level, it may be difficult to align the electrode tabs of the electrode assembly.

However, as described above, the method of designing the rechargeable battery (S100, see FIG. 5) according to the present disclosure automates the process of setting the position of the electrode tab (211, see FIG. 6), so that the position of the electrode tab (211, see FIG. 6) may be accurately set regardless of the user's skill level.

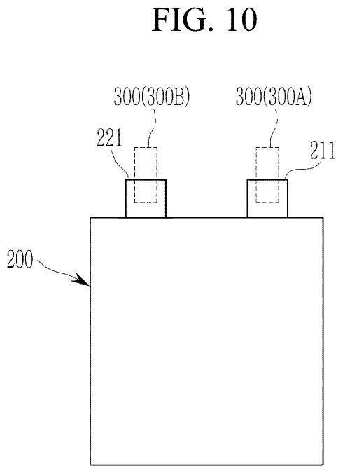

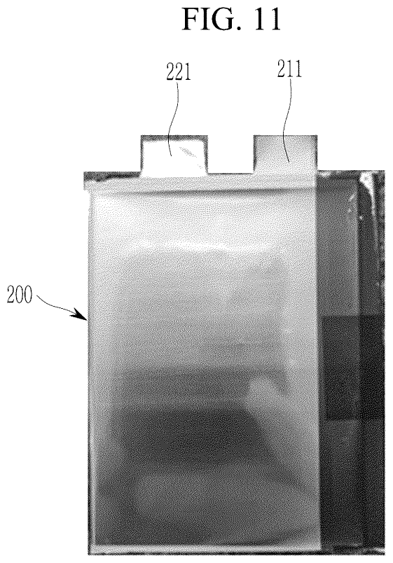

Referring to FIGS. 10 and 11, in the process of winding a laminate including a separator and an electrode plate to manufacture the electrode assembly 200, the first electrode tabs 211 may be aligned with each other, and the second electrode tabs 221 may be aligned with each other.

Meanwhile, the electrode assembly 200 of the rechargeable battery manufactured by the method of designing the rechargeable battery (S100, see FIG. 5) as described above may satisfy Equation 1, and a further detailed description thereof will be omitted as it has been described in the method of designing the rechargeable battery (S100, see FIG. 5).

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the disclosed embodiments of the present invention.

While aspects of some embodiments of the present disclosure have been described in connection with what is presently considered to be practical embodiments, the drawings and the detailed description of embodiments according to the present disclosure which are described above are merely illustrative, are just used for the purpose of describing aspects of some embodiments of the present disclosure, and are not used for qualifying the meaning or limiting the scope of embodiments according to the present disclosure, which is disclosed in the appended claims, and their equivalents. Therefore, it should be understood by those skilled in the art that various modifications and other equivalent embodiments may be made from the present disclosure. Accordingly, some embodiments according to the present disclosure are defined by the appended claims, and their equivalents.

Description of Some of the Reference Symbols

| | |
|---|---|
| 100: Rechargeable battery | 200: Electrode assembly |
| 210: First electrode plate | 211: First electrode tab |
| 220: Second electrode plate | 221: Second electrode tab |
| 230: Separator | 400: Case |

What is claimed is:

1. A method of designing a rechargeable battery, the method comprising:
a numerical value entering operation for entering detailed numerical values for a case, a separator, and an electrode plate;
a calculation operation for deriving X and a until the following Equation 1 is satisfied; and
a position-setting operation for setting the position of an electrode tab to be arranged on one side of the electrode plate
$${\sum }_{k = 1}^{n} ( X + ( k - 1 ) a ) = M - G \qquad Equation 1$$
(M is a length of the electrode plate, G is a length of an uncoated portion without an active material layer on the electrode plate, n is twice a number of windings (×2), X is a length of a unit electrode plate when wound 0.5 times, and a is an increase in the length of the unit electrode plate per winding).

2. The method of designing the rechargeable battery as claimed in claim 1, wherein
in the calculation operation,
X and a are derived using one of trial and error, exhaustive search, gradient method, generic algorithm (GA), and particle swarm optimization (PSO).

3. The method of designing the rechargeable battery as claimed in claim 1, wherein
X in the calculation operation is a value included in a range of 60% to 90% of a width of the case.

4. The method of designing the rechargeable battery as claimed in claim 1, wherein
in the position-setting operation,
a distance from the center of the unit electrode plate to the center of the electrode tab is set to be the same for each of the number of windings.

5. The method of designing the rechargeable battery as claimed in claim 1, further comprising:
a number-setting operation for setting the number of electrode tabs.

6. The method of designing the rechargeable battery as claimed in claim 5, wherein
in the number-setting operation,
electrode tabs except for required electrode tabs are deleted from an entirety of the electrode tabs.

7. A rechargeable battery, comprising:
an electrode assembly including:
a separator; and
a first electrode plate, and a second electrode plate, with the separator therebetween; and
a case for accommodating the electrode assembly,
wherein the electrode assembly satisfies the following Equation 1
$${\sum }_{k = 1}^{n} ( X + ( k - 1 ) a ) = M - G \qquad Equation 1$$
(M is a length of the first electrode plate, G is a length of an uncoated portion without an active material layer on the first electrode plate, n is twice a number of windings (×2), X is a length of a unit electrode plate when wound 0.5 times, and a is an increase in the length of the unit electrode plate per winding).

8. The rechargeable battery as claimed in claim 7, wherein
the first electrode plate comprises a coated portion having an active material layer.

9. The rechargeable battery as claimed in claim 7, wherein
the first electrode plate comprises a coated portion having the active material layer; and
an uncoated portion without the active material layer.

10. The rechargeable battery as claimed in claim 7, wherein
the first electrode plate is one of a positive electrode plate and a negative electrode plate, and the second electrode plate is the other of the positive electrode plate and the negative electrode plate.
